(19) United States
(12) Patent Application Publication
(10) Pub. No.: US 2011/0274799 A1
(43) Pub. Date: Nov. 10, 2011

(54) Mold Inhibiting Emulsion

(75) Inventors: Robert O. Wilhelm, JR., Jefferson Hills, PA (US); Ada Lacayo, Lower Burrell, PA (US); Cathlene Colley, Pittsburgh, PA (US); James Galicic, Pittsburgh, PA (US); Michael Hewitt, Aliquippa, PA (US); Don Huber, Pittsburgh, PA (US)

(73) Assignee: Mallet and Company, Inc.

(21) Appl. No.: 13/102,417

(22) Filed: May 6, 2011

Related U.S. Application Data
(60) Provisional application No. 61/333,012, filed on May 10, 2010.

(51) Int. Cl. A21D 2/00; A01P 3/00; A01N 37/06

(52) U.S. Cl. 426/303; 426/310; 118/663; 514/557

(57) ABSTRACT

A mold inhibiting emulsion including: an aqueous phase that includes water; a non-aqueous phase that may optionally include an oil; at least one emulsifier; and at least one mold inhibitor. Also provided is a method of inhibiting mold growth on edible baked products (e.g., bread) that involves applying the mold inhibiting emulsion of the present invention to the exterior surfaces of unbaked dough from which the edible baked product is prepared. The mold inhibiting emulsion may be applied to contact surfaces of a vessel in which dough is baked, and then to upper portions of the dough after it has been placed into the treated vessel. An apparatus for treating the exterior surfaces of unbaked dough with spray applied liquids, is further provided. The apparatus includes first and second spray stations each including a primary spray assembly and a secondary spray assembly activated if the primary spray assembly fails.

### CROSS REFERENCE TO RELATED APPLICATIONS

This application claims the benefit of priority from Provisional Patent Application No. 61/333,012, filed May 10, 2010, the contents of which are incorporated herein in its entirety.

### BACKGROUND OF THE INVENTION

1. Field of the Invention

The present invention relates to mold inhibiting emulsions that include aqueous and non-aqueous phases, at least one emulsifier and at least one mold inhibitor. The present invention also relates to a method of inhibiting mold growth associated with edible baked products, such as bread products, that involves treating the exterior surfaces of unbaked dough with the mold inhibiting emulsion, and then baking the surface treated unbaked dough. The present invention further relates to an apparatus for treating the exterior surfaces of unbaked dough with the mold inhibiting emulsion.

2. Description of the Related Art

Edible baked products, such as bread, are susceptible to mold growth, for example, during storage. Preservatives are often used to minimize or inhibit mold growth associated with edible baked products. Examples of such preservatives include salts of propionic acid, typically referred to as propionates, and salts of sorbic acid, which are typically referred to as sorbates. Preservatives are typically added to and mixed with the ingredients from which the edible baked products are made. For example, preservatives for purposes of inhibiting the growth of mold are typically mixed directly with the ingredients (e.g., flour, salt, leavening agents, and water) from which the unbaked dough is prepared. The unbaked dough, with the preservatives mixed therein and distributed substantially homogeneously there-throughout, is then baked to form the edible baked product.

The introduction of preservatives into the unbaked dough often has disadvantages associated therewith. In the case of yeast leavened bread, for example, preservatives that inhibit mold growth typically also inhibit growth of the leavening yeast, which can result in dough that does not rise to a sufficient extent. Generally, to offset the yeast inhibiting effects of preservatives that inhibit mold growth, higher levels of leavening yeast are required, which can increase costs and shift the flavor profile of the resulting baked product. The presence of preservatives, such as mold growth inhibitors within and throughout the dough, can result in undesirable off-flavors in the resulting baked products, in particular when higher levels of preservatives are required. The effectiveness of some mold inhibitors is pH dependent. For example, at pH values in excess of 5, the effectiveness of some mold inhibitors is degraded. Depending on the presence of other additives, the pH of dough can rise above 5, resulting in degraded effectiveness of some preservatives that inhibit mold growth. With large scale production methods, the addition of preservatives, which are often in the form of a particulate solid, may adversely affect human operators near the mixer, resulting in, for example, skin and/or respiratory irritation.

The spray application of water based mold inhibitors onto the surface of edible baked products while the edible baked products retain heat of baking is known. For example, a water based mold inhibitor is sprayed onto the surface of an edible baked product shortly after it is removed from the baking oven. The spray application of water based mold inhibitors onto the hot surface of an edible baked product, such as bread, can be problematic. For example, uniform coverage and/or sufficient adhesion of the mold inhibitor to the surface of the baked product may be undesirably variable. In addition, such baked product spray application processes typically require additional process steps. In an attempt to achieve application to the whole surface, the baked product is typically removed from the baking pan, placed on a belt, removed from the belt, transported to a spray application unit, and then transported back and placed on the belt.

It would be desirable to develop new mold inhibiting compositions that are not subject to the disadvantages discussed above. In addition, it would be desirable to develop new methods and apparatuses that make use of such newly developed mold inhibiting compositions. It would be further desirable that such newly developed mold inhibiting compositions, methods, and apparatuses allow for the use of a minimum amount of molding inhibiting agents, without a reduction in the mold resistance of the edible baked product.

### SUMMARY OF THE INVENTION

In accordance with the present invention there is provided, a mold inhibiting emulsion comprising:

(a) an aqueous phase comprising water;

(b) a non-aqueous phase;

(c) at least one emulsifier; and

(d) at least one mold inhibitor,

wherein said mold inhibiting emulsion has a viscosity of at least 100 cps at 27° C.

In further accordance with the present invention, there is provided a method of inhibiting mold growth on an edible baked product comprising:

(a) providing the above described mold inhibiting emulsion;

(b) treating an exterior surface of an unbaked dough with said mold inhibiting emulsion, thereby forming a treated unbaked dough; and

(c) baking said treated unbaked dough, thereby forming said edible baked product.

There is also provided, in accordance with the present invention, an apparatus for treating an exterior surface of an unbaked dough, comprising:

(a) a first station comprising at least one first nozzle, each first nozzle having a (i.e., its own) first spray sensor, at least one second nozzle, each second nozzle having a (i.e., its own) second spray sensor, and a first station vessel location sensor;

(b) a second station comprising at least one third nozzle, each third nozzle having a (i.e., its own) third spray sensor, at least one fourth nozzle, each fourth sensor having a (i.e., its own) fourth spray sensor, and a second station vessel location sensor, said first station and said second station being remote from each other;

(c) a first pump that is in fluid communication with each first nozzle by means of a first conduit (e.g., optionally including a header in the case of two or more first nozzles), a second pump that is in fluid communication with each second nozzle by means of a second conduit (e.g., optionally including a header in the case of two or more second nozzles), a third pump that is in fluid communication with each third nozzle by means of a third conduit (e.g., optionally including a header in the case of two or more third nozzles), and a fourth pump that is in fluid communication with each fourth nozzle by means of a fourth conduit (e.g., optionally including a header in the case of two or more fourth nozzles),
wherein said first pump, said second pump, said third pump, and said fourth pump each independently have a pump activation sensor, and
wherein said first conduit, said second conduit, said third conduit, and said fourth conduit each independently have a liquid flow sensor; and

(d) a programmable controller that is independently controllably coupled to each of said first pump, said second pump, said third pump, and said fourth pump;
wherein said first station vessel location sensor and said second station vessel location sensor are each independently electrically connected to said programmable controller,
wherein said each spray sensor, each second spray sensor, each third spray sensor, and each fourth spray sensor are each independently electrically connected to said programmable controller,
wherein the pump activation sensor of each of said first pump, said second pump, said third pump, and said fourth pump is in each case independently electrically connected to said programmable controller, and
wherein the liquid flow sensor of each of said first conduit, said second conduit, said third conduit, and said fourth conduit is in each case independently electrically connected to said programmable controller,
   wherein said first station vessel sensor is adapted to inform said programmable controller that a vessel is present within said first station, said programmable controller activating said first pump to introduce a first liquid (e.g., a mold inhibiting emulsion according to the present invention) through said first conduit into each first nozzle and onto a contact surface of said vessel,
   wherein if at least one of, said pump activation sensor of said first pump detects failure of said first pump, said liquid flow sensor of said first conduit detects failure of flow of said first liquid therethrough, or at least one first spray sensor detects failure of said first liquid to spray from at least one first nozzle, said programmable controller activates said second pump to introduce said first liquid through said second conduit into each second nozzle and onto said contact surface of said vessel from at least one second nozzle,
   wherein if at least one of, said pump activation sensor of said second pump detects failure of said second pump, said liquid flow sensor of said second conduit detects failure of flow of said first liquid therethrough, or at least one second spray sensor detects failure of said first liquid to spray from at least one second nozzle, said programmable controller transmits a first station failure alarm,
   wherein said second station vessel sensor is adapted to inform said programmable controller that said vessel, having unbaked dough therein, is present within said second station, said programmable controller activating said third pump to introduce a second liquid (e.g., a mold inhibiting emulsion according to the present invention) through said third conduit into each third nozzle and onto an upper portion of said exterior surface of said unbaked dough that is free of contact with said contact surface of said vessel,
   wherein if at least one of, said pump activation sensor of said third pump detects failure of said third pump, said liquid flow sensor of said third conduit detects failure of flow of said second liquid therethrough, or at least one third spray sensor detects failure of said second liquid to spray from at least one third nozzle, said programmable controller activates said fourth pump to introduce said second liquid through said fourth conduit into each fourth nozzle and onto said upper portion of said exterior surface of said unbaked dough from at least one fourth nozzle, and
   wherein if at least one of, said pump activation sensor of said fourth pump detects failure of said fourth pump, said liquid flow sensor of said fourth conduit detects failure of flow of said second liquid therethrough, or at least one fourth spray sensor detects failure of said second liquid to spray from at least one fourth nozzle, said programmable controller transmits a second station failure alarm.

The first liquid and the second liquid may be the same or different. In an embodiment, the first liquid and the second liquid are each independently selected from a mold inhibiting emulsion according to the present invention.

The features that characterize the present invention are pointed out with particularity in the claims, which are annexed to and form a part of this disclosure. These and other features of the invention, its operating advantages and the specific objects obtained by its use will be more fully understood from the following detailed description and accompanying drawings in which preferred embodiments of the invention are illustrated and described.

As used herein and in the claims, terms of orientation and position, such as “upper”, “lower”, “inner”, “outer”, “right”, “left”, “vertical”, “horizontal”, “top”, “bottom”, and similar terms, are used to describe the invention as oriented in the drawings. Unless otherwise indicated, the use of such terms is not intended to represent a limitation upon the scope of the invention, in that the invention may adopt alternative positions and orientations.

Unless otherwise indicated, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 6.1, 3.5 to 7.8, 5.5 to 10, etc.

Unless otherwise indicated, all numbers or expressions, such as those expressing structural dimensions, quantities of ingredients, etc., as used in the specification and claims are understood as modified in all instances by the term “about.”

### BRIEF DESCRIPTION OF THE DRAWINGS

FIG. 1 is a representative schematic elevational view of an apparatus according to the present invention;

FIG. 2 is a representative schematic plan view of a reservoir, pumps and nozzles of an apparatus according to the present invention;

FIG. 3 is a schematic representation of a pump station that may be used with the apparatus of the present invention; and

FIG. 4 is a schematic representation of the connections between a programmable controller and the various pumps and sensors of the first station of the apparatus of the present invention.

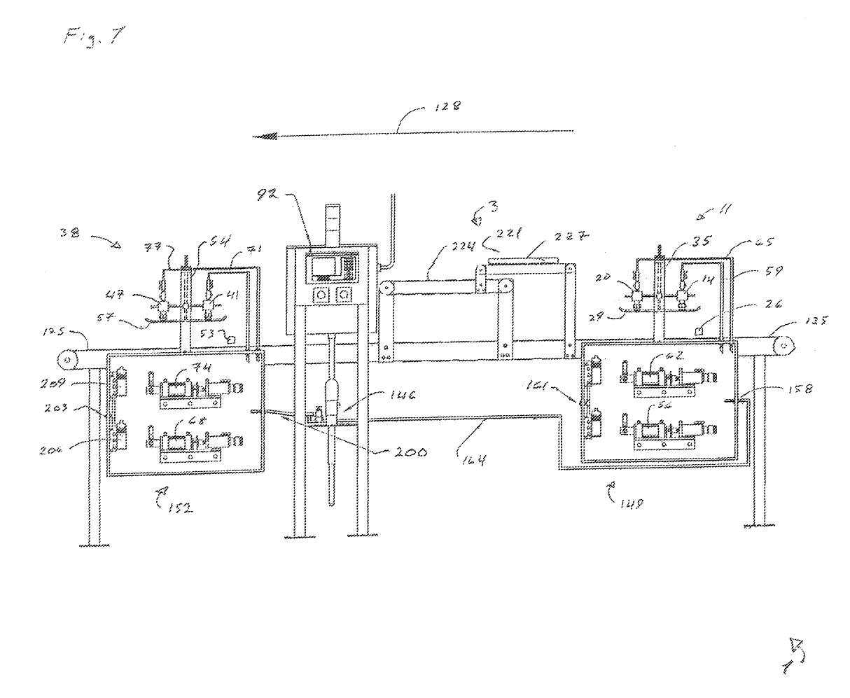

In FIGS. 1 through 4, like reference numerals designate the same components and structural features, unless otherwise indicated.

### DETAILED DESCRIPTION OF THE PREFERRED EMBODIMENTS

The mold inhibiting emulsions, methods and apparatuses of the present invention are useful for purposes of inhibiting mold growth on or associated with (e.g., inhibiting mold growth on the exterior or that may also invade the interior of) edible baked products. As such, the mold inhibiting emulsions, methods, and apparatuses of the present invention may also be described as being useful for purposes of extending the shelf life of edible baked products. The edible baked products are suitable for consumption by humans and animals, and are prepared from unbaked dough that typically includes flour. The flour is generally prepared from grains, and may be selected from, for example, wheat flour, corn flour, rye flour, oat flour, sorghum flour, and/or barley flour.

The edible baked products may be leavened or unleavened. The unbaked dough from which leavened edible baked products may be prepared typically include a yeast leavening agent (e.g., Saccharomyces cerevisiae, which is commonly referred to as baker's yeast) and/or a chemical leavening agent (e.g., sodium bicarbonate).

Examples of edible baked products include, but are not limited to, bread, including leavened bread and unleavened bread (e.g., tortillas, pizza crust, and pita bread), cakes, pancakes, biscuits, cookies, and pie crusts. The mold inhibiting emulsions, methods and apparatuses of the present invention are particularly useful with breads, such as sandwich breads, buns, rolls, and bagels.

The mold inhibiting emulsions of the present invention comprise a mold inhibitor, which may be selected from known mold inhibitors. In an embodiment, the mold inhibitor is selected from sorbic acid, sodium sorbate, potassium sorbate, calcium sorbate, propionic acid, sodium propionate, potassium propionate, calcium propionate, benzoic acid, sodium benzoate, potassium benzoate, calcium benzoate, and combinations of two or more thereof.

The mold inhibiting agent is typically present in the emulsion in an amount that is at least sufficient for purposes of inhibiting mold growth on or associated with edible baked products with which the emulsions are used. As such, the amount of mold inhibitor present in the emulsions of the present invention may vary widely. Generally, the mold inhibitor is present in the mold inhibiting emulsion in an amount of less than or equal to 10 percent by weight, based on total weight of the mold inhibiting emulsion. For example, the mold inhibitor may be present in the mold inhibiting emulsion in an amount of from 0.1 percent by weight to 10 percent by weight, or 0.5 percent by weight to 8 percent by weight, or 1 percent by weight to 5 percent by weight, based on total weight of the mold inhibiting emulsion.

The mold inhibitor may be present substantially within the aqueous phase of the emulsion, substantially within the non-aqueous phase of the emulsion, or present within both the aqueous phase and the non-aqueous phase of the emulsion. The phase within which the mold inhibitor resides depends on factors including, but not limited to, the solubility (e.g., water solubility) of the mold inhibitor, the emulsifier(s) used, and the composition of the non-aqueous phase (e.g., the types of oil or oils present).

The emulsifier is selected such that the mold inhibiting emulsion is stable (e.g., undergoes a minimum of coagulation and/or settling upon storage under ambient conditions). The emulsifier of the mold inhibiting emulsions of the present invention may be selected from nonionic emulsifiers, cationic emulsifiers, anionic emulsifiers, and/or zwitterionic emulsifiers. The emulsifier may be selected from art-recognized food grade emulsifiers. In an embodiment, the emulsifier is selected from monoglycerides, diglycerides, polysorbates, polyglycerol esters, lecithins, and combinations of two or more thereof.

The monoglyceride and diglyceride emulsifiers may be selected from fatty acid esters of glycerin, in which the fatty acids are selected from, for example, palmitic acid, stearic acid, oleic acid, linoleic acid, and/or alpha-linolinic acid. The acids of the monoglyceride and diglyceride emulsifiers may alternatively be selected from lower molecular weight (e.g., non-fatty) acids, such as acetic acid, lactic acid, citric acid, succinic acid, and diacetyl tartaric acid.

The polysorbate emulsifiers may be selected from fatty acid polysorbates, in which the fatty acid is selected from, for example, palmitic acid, stearic acid, oleic acid, linoleic acid, and/or alpha-linolinic acid. Examples of polysorbates that may be used in the present invention include, but are not limited to polysorbate 60 (POE sorbitan mono stearate) and polysorbate 80 (POE sorbitan mono oleate).

Polyglycerol esters from which the emulsifier may be selected include, for example, polyglycerol esters of fatty acids. The fatty acids of the polyglycerol esters may be selected from, for example, palmitic acid, stearic acid, oleic acid, linoleic acid, and/or alpha-linolinic acid.

Lecithins from which the emulsifier may be selected include, for example, plant lecithins (e.g., derived from soybeans, corn, or rapeseed), fractionated lecithins, and/or yolk lecithins.

The emulsifier is typically present in the mold inhibiting emulsions of the present invention in at least a stabilizing amount (e.g., an amount such that the mold inhibiting emulsion undergoes a minimum of coagulation and/or settling upon storage under ambient conditions). As such, the emulsifier may be present in the mold inhibiting emulsion in a wide range of amounts. Generally, the emulsifier is present in the mold inhibiting emulsion in an amount that is less than or equal to 30 percent by weight, based on total weight of the emulsion. For example, the emulsifier may be present in an amount of from 0.1 percent by weight to 30 percent by weight, or 0.5 percent by weight to 25 percent by weight, or from 1 percent by weight to 20 percent by weight, based on total weight of the mold inhibiting emulsion.

The mold inhibiting emulsions of the present invention also comprise an aqueous phase that includes water, and a non-aqueous phase that may optionally include an oil. In addition, the mold inhibiting emulsions of the present invention include a discontinuous phase that is dispersed within a continuous phase. The aqueous phase and non-aqueous phase may each be present in a wide range of amounts, provided the emulsion is stable. For example, the aqueous phase may be present in an amount of from 1 percent by weight to 99 percent by weight, or 20 percent by weight to 80 percent by weight, or from 25 percent by weight to 75 percent by weight, based on the weight of the aqueous phase and the non-aqueous phase. The non-aqueous phase, may correspondingly be present in an amount of 1 percent by weight to 99 percent by weight, or 20 percent by weight to 80 percent by weight, or from 25 percent by weight to 75 percent by weight, based on the weight of the aqueous phase and the non-aqueous phase.

In an embodiment, the continuous phase of the mold inhibiting emulsion comprises or includes the aqueous phase, and correspondingly the discontinuous (or dispersed) phase comprises or includes the non-aqueous phase. An emulsion in which the continuous phase is the aqueous phase may be described generally as an oil-in-water (O/W) emulsion. When the continuous phase is the aqueous phase, water may be present in the emulsion in a wide range, provided the emulsion is stable. Typically, when the continuous phase is the aqueous phase, water is present in an amount that is greater than 50 percent by weight, and less than 100 percent by weight, based on total weight of the emulsion. For example, water may be present in an amount of from 51 percent by weight to 95 percent by weight, or 60 percent by weight to 85 percent by weight, or from 65 percent by weight to 80 percent by weight, based on total weight of the mold inhibiting emulsion.

When the continuous phase is the aqueous phase, the non-aqueous phase (which correspondingly is the discontinuous phase) may optionally include an oil (e.g., a vegetable oil, animal oil/fat, and/or synthetic oil). If present, the oil is typically present in an amount of less than 50 percent by weight, based on the total weight of the mold inhibiting emulsion. For example, when the continuous phase is the aqueous phase, an oil may be present in an amount of from 1 percent by weight to 49 percent by weight, or from 5 percent by weight to 45 percent by weight, or from 10 percent by weight to 40 percent by weight, based on total weight of the mold inhibiting emulsion.

In an embodiment of the present invention, when the continuous phase is the aqueous phase, the non-aqueous phase (which is the discontinuous phase) is free of an oil (e.g., vegetable oils, animal fats/oils, and/or synthetic oils), and is defined substantially by the emulsifier.

In a further embodiment of the present invention, when the continuous phase is the aqueous phase, the non-aqueous phase (which is the discontinuous phase) is free of an oil (e.g., vegetable oils, animal fats/oils, and/or synthetic oils), and is defined substantially by the emulsifier, and the mold inhibitor resides in the aqueous phase, or in the non-aqueous phase, or in a combination of the aqueous phase and the non-aqueous phase. In a particular embodiment, when the continuous phase is the aqueous phase, the non-aqueous phase (which is the discontinuous phase) is free of an oil (e.g., vegetable oils, animal fats/oils, and/or synthetic oils), and is defined substantially by the emulsifier, and the mold inhibitor resides substantially in the aqueous phase.

In an embodiment where the continuous phase is the aqueous phase, and the non-aqueous phase is free of an oil, water is typically present in an amount of greater than 50 percent by weight, based on total weight of the mold inhibiting emulsion, for example, from 60 to 90 percent by weight, or 65 to 85 percent by weight, based on total weight of the mold inhibiting emulsion. With this particular embodiment, the emulsifier may be present in an amount of at least 5 percent by weight, based on total weight of the mold inhibiting emulsion, for example, from 5 to 25 percent by weight, or 10 to 20 percent by weight, based on total weight of the mold inhibiting emulsion.

In an embodiment of the present invention, the continuous phase is or includes the non-aqueous phase, and correspondingly the discontinuous phase is or includes the aqueous phase. An emulsion in which the continuous phase is the non-aqueous phase may be described generally as a water-in-oil (W/O) emulsion. When the continuous phase is or includes the non-aqueous phase, the non-aqueous phase includes an oil.

Oils that may be present in the mold inhibiting emulsions of the present invention include, but are not limited to vegetable oils, animal fats, or oils (including fish oils), and/or synthetic oils (e.g., food grade mineral oils). Examples of oils that may be used in the mold inhibiting emulsions of the present invention include, but are not limited to coconut oil, palm oil, palmkernel oil, ground nut oil (e.g., peanut oil), safflower oil, tallow, erucic rape oil (including high and low erucic rape oil), soybean oil and combinations of two or more thereof.

When the continuous phase is the non-aqueous phase, oil may be present in the emulsion in a wide range, provided the emulsion is stable. Typically, when the continuous phase is the non-aqueous phase, oil may be present in an amount that is greater than 50 percent by weight, and less than 100 percent by weight, based on total weight of the emulsion. For example, oil may be present in an amount of from 51 percent by weight to 95 percent by weight, or 60 percent by weight to 85 percent by weight, or from 65 percent by weight to 80 percent by weight, based on total weight of the mold inhibiting emulsion.

When the continuous phase is the non-aqueous phase, the mold inhibitor may be present in the aqueous phase (which is the discontinuous or dispersed phase), or in the non-aqueous phase, or in a combination of the aqueous phase and the non-aqeuous phase. In an embodiment, when the continuous phase is the non-aqueous phase, the mold inhibitor is present substantially within the aqueous phase. In a further embodiment, when the continuous phase is the non-aqueous phase, the mold inhibitor is present substantially within the non-aqueous phase.

The mold inhibiting emulsions of the present invention have a viscosity that allows them to be efficiently applied to the exterior surface of unbaked dough and the contact surfaces of a vessel in which and/or on which the unbaked dough is baked to form the edible baked product. Generally, the viscosity is selected such that the mold inhibiting emulsions of the present invention are liquid and free flowing, and are efficiently applicable to the exterior surface an unbaked dough material (e.g., so as to minimize excess run-off, and maximize flow and coverage over the exterior surface thereof). In an embodiment, the mold inhibiting emulsions of the present invention have a viscosity of at least 100 centipoise (cps) at 27° C. The upper viscosity limit of the mold inhibiting emulsion is generally less than or equal to 25,000 cps at 27° C. In an embodiment, the viscosity of the mold inhibiting emulsion is from 100 to 5000 cps at 27° C., or from 200 to 3000 cps at 27° C., or from 500 to 2500 cps at 27° C. The viscosity of the mold inhibiting emulsions of the present invention may be measured by art-recognized methods. For example, the viscosity of the mold inhibiting emulsions may be measured with a Brookfield viscometer model number RVF, using a number 3 spindle at 20 rpm, which is available commercially from Brookfield Engineering Laboratories, Inc.

The mold inhibiting emulsions of the present invention may further comprise additional agents or additives. Examples of additives include, but are not limited to: adhesion promoters, such as starches; enzymes, such as beta-amylase, pH modifiers, such as citric acid, that can be added for reasons including, but not limited to stabilizing the emulsion. Adhesion promoters, such as starches, may be included for purposes of improving adhesion of the mold inhibiting emulsion to the exterior surface of an unbaked dough material to which it is applied (e.g., by means of spray application). Additives are typically present in the mold inhibiting emulsions in amounts of less than or equal to 10 percent by weight, based on total weight of the mold inhibiting emulsion. For example, additives may be present in amounts of from 0.1 percent by weight to 5 percent by weight, or 0.5 percent by weight to 3 percent by weight, based on total weight of the mold inhibiting emulsion.

In an embodiment, the mold inhibiting emulsion is free of pH adjusting agents, such as acid-base buffers. Examples of pH adjusting agents that may be excluded from the mold inhibiting emulsions of the present invention include, but are not limited to triacetin, monocalcium phosphate, citric acid, pyrophosphate, sodium phosphate, potassium phosphate, and combinations of two or more thereof.

The mold inhibiting emulsions of the present invention may be prepared by art-recognized methods. For example, the components of the emulsion may be first mixed in a suitable container using an impeller, to form a premix. The premix is then typically subjected to higher shear, for example, by passing it through a homogenizer operated at elevated pressures (e.g., 1000 to 3000 psi) or other mixing equipment to produce a stable emulsion. Mold inhibiting emulsions according to the present invention may have a wide range of average particle sizes, provided the emulsion is stable (e.g., showing minimum settling on storage).

The present invention also relates to a method of inhibiting mold growth on edible baked products, such as leavened bread. The method includes providing the mold inhibiting emulsion of the present invention, as described previously herein. At least a portion of the exterior surface of an unbaked dough material is treated with the mold inhibiting emulsion, so as to form a treated unbaked dough. The treated unbaked dough is then baked, so as to result in formation of the edible baked product.

With leavened edible baked products, the mold inhibiting emulsion may be applied to the exterior surface of the unbaked dough, before the dough has risen, while the dough is rising, and/or after the dough has risen. In an embodiment, the mold inhibiting emulsion may be applied to the exterior surface of the unbaked dough, before the dough has risen.

As used herein and in the claims, the term “unbaked dough” means dough that has not been subjected to elevated temperatures (i.e., baked) for a time at least sufficient to form (or be converted to) an edible baked product. For example, unbaked dough, with regard to the present invention, is generally maintained at temperatures of greater than 0° C., and less than or equal to 66° C., and more typically less than or equal to 38° C., such as at room temperature (e.g., 25° C.).

The mold inhibiting emulsion may be applied over a portion of the exterior surface of the unbaked dough. In an embodiment, the mold inhibiting emulsion is applied over substantially all (or the whole of) the exterior surface of the unbaked dough.

The mold inhibiting emulsion may be applied to the exterior surface of the unbaked dough by any suitable method. Examples, of methods by which the mold inhibiting emulsion may be applied to the exterior surface of the unbaked dough include, but are not limited to: brushing the emulsion onto the exterior surface; curtain coating, (e.g., passing the unbaked dough through a falling curtain of the emulsion); immersion (e.g., immersing or dipping the unbaked dough into the emulsion); and/or applying the emulsion to the exterior surface of the dough in the form of an atomized emulsion (e.g., by spraying).

In an embodiment, treating the exterior surface of the unbaked dough involves applying the mold inhibiting emulsion as (or in the form of) an atomized mold inhibiting emulsion to the exterior surface of the unbaked dough. The unbaked dough may, for example, be passed through a chamber having atomized mold inhibiting emulsion suspended therein. The mold inhibiting emulsion may be applied to the exterior surface of the unbaked dough by spray methods. The mold inhibiting emulsion may be atomized by passage through the nozzle of a spray gun, which directs the atomized mold inhibiting emulsion onto the exterior surface of the unbaked dough. Spray guns that may be used to atomize the emulsion include, but are not limited to, gas assisted spray guns (which use pressurized gas, such as air, nitrogen, and/or CO₂, to atomize and/or propel the emulsion), and gasless (e.g., airless) spray guns. The mold inhibiting emulsion may be atomized by means of a spray gun fitted with a spinning bell and/or disk. When the vessel, to which the mold inhibiting emulsion is applied in an embodiment of the present invention, is fabricated from an electrically conductive material, such as metal, the mold inhibiting emulsion may be applied by electrostatic spray equipment, in accordance with art-recognized methods.

In a further embodiment, treating the exterior surface of the unbaked dough involves applying a first mold inhibiting emulsion to the contact surface(s) of a vessel in which the dough is to be baked, and then applying a second mold inhibiting emulsion to the upper exposed exterior surfaces of the dough while it resides in the treated vessel. More particularly, the method involves providing a first mold inhibiting emulsion and a second mold inhibiting emulsion which are each independently selected from the mold inhibiting emulsion of the present invention. The first and second mold inhibiting emulsions may be the same or different (i.e., they may have the same or different compositions, provided they are each selected from the mold inhibiting emulsion of the present invention). For example, the continuous phase of the first mold inhibiting emulsion may be the non-aqueous phase (e.g., a W/O emulsion), and the continuous phase of the second mold inhibiting emulsion may be the aqueous phase (e.g., an O/W emulsion). Alternatively, the aqueous phase of the first and second mold inhibiting emulsions may in each case be the continuous phase (e.g., each being an O/W emulsion), and the non-aqueous phase of the first mold inhibiting emulsion includes an oil, while the non-aqueous phase of the second mold inhibiting emulsion is substantially free of an oil. In an embodiment, the first and second mold inhibiting emulsions are substantially the same (i.e., they each have substantially the same composition).

When the mold inhibiting emulsion is applied to both the vessel and the dough, the method of the invention involves applying the first mold inhibiting emulsion to at least a contact surface of a vessel in which said unbaked dough is baked (i.e., later baked), thereby forming a treated vessel. As used herein and in the claims, the term “vessel” means: (i) a vessel having walls and interior surfaces in which the dough is baked; or (ii) a vessel or support (e.g., a sheet) having upper surfaces on which the dough is baked. The vessel may be fabricated from suitable materials in which dough is baked, such as, metals, stone, and/or ceramic materials (e.g., glass). As used herein and in the claims, the term “contact surface(s)” means those surfaces of the vessel that are or come into contact with the dough, when the dough is introduced into/onto the vessel. The first mold inhibiting emulsion is applied to at least the contact surfaces of the vessel, and is typically applied to more than the contact surfaces including the interior/upper surfaces of the vessel that do not contact the dough.

In an embodiment, the first mold inhibiting emulsion is applied to substantially all of the contact surfaces of the vessel. In addition to substantially all of the contact surfaces of the vessel, the first mold inhibiting emulsion may also be applied to further surfaces of the contact vessel (e.g., the entire interior or upper surfaces of the vessel). The second mold inhibiting emulsion may be applied to substantially all of the upper portion of the exterior surfaces of the unbaked dough, as it resides within the treated vessel.

Next, the unbaked dough is introduced into the treated vessel (that has been treated with the first mold inhibiting emulsion). While residing in the treated vessel, an upper portion of the exterior surface of the unbaked dough is free of contact with the contact surface(s) of the treated vessel. The upper portion of the exterior surface of the unbaked dough may also include side exterior surfaces thereof.

With the unbaked dough residing within the treated vessel, the second mold inhibiting emulsion is applied to the upper portion of the exterior surface of the unbaked dough. The so treated unbaked dough is then baked, thereby resulting in the formation of an edible baked product upon which mold growth is inhibited. By treating the contact surfaces of the vessel in which the unbaked dough is baked, and the upper portion of the exterior surface of the unbaked dough, while it resides within the treated vessel, the exterior surface (e.g., substantially all or the whole of the exterior surface) of the unbaked dough is treated, without the need to further handle and/or treat the dough or resulting edible baked product.

The unbaked dough, in an embodiment of the method of the present invention, includes a relatively small amount of mold inhibitor incorporated therein (which may be selected from those classes and examples of mold inhibitors described previously herein). When present, the mold inhibitor is typically included with the materials from which the dough is made (e.g., the flour, water, salt, and yeast), and is typically present in an amount that is less than or equal to about 10 percent of the amount typically used in the absence of the method of the present invention. In the method of the present invention, the mold inhibitor may be present in the dough in amounts of less than or equal to 0.5 percent by weight, based on total weight of the dough, for example, from 0.01 to 0.5 percent by weight, or from 0.02 to 0.01 percent by weight, based on total weight of the dough.

The mold inhibiting emulsions, methods and apparatuses of the present invention may be used to provide edible baked products (e.g., prepared in accordance with the methods and/or using the apparatuses of the present invention) having desirable resistance to the growth of mold thereon during storage. Examples of molds whose growth is so inhibited by the mold inhibiting emulsions, methods and apparatuses of the present invention, include, but are not limited to, Penicillium, Aspergillus, Rhizopus, Monascus, Fusarium, and combinations of two or more thereof. For example, edible baked products, such as bread, prepared in accordance with the methods of the present invention when stored at ambient temperatures and humidity in twist tied closed polyethylene bags, typically do not show visual signs of mold growth until 5 or more days, or 10 or more days, or 15 or more days, or 20 or more days, or 25 or more days, or 30 or more days, or 35 or more days, or 40 or more days, or 45 or more days, or 50 or more days, or 55 or more days, after baking. The initial onset of mold growth is typically detected visually as discoloration (e.g., discolored spots of about 1 to about 2 mm in diameter, or visible to the naked eye) on the surface of the edible baked product. The discoloration may include one or more colors, such as, grays, greens, blacks, and/or reds.

The present invention also relates to an apparatus that may be used to treat the exterior surface of an unbaked dough with one or more spray applied liquids, such as the mold inhibiting emulsions of the present invention. The apparatus includes a first station that spray applies a first liquid onto the contact surfaces of a vessel (in which unbaked dough is later baked), and a second station that spray applies a second liquid onto the contact surfaces of the upper portion of the exterior surfaces of unbaked dough that resides within the vessel. The first and second stations each include a primary spray assembly and a secondary spray assembly. If the primary spray assembly fails, the secondary spray assembly is activated. If the secondary spray assembly fails, a station failure alarm is transmitted, and optionally the line is shut down.

The first liquid and second liquid may each independently be selected from liquids suitable for treating vessel contact surfaces and/or the exterior surfaces of unbaked dough products. The first liquid and the second liquid may be the same or different. For example, the first liquid and second liquid may each independently be selected from release liquids (e.g., for purposes of releasing baked dough from vessel contact surfaces), flavoring liquids, and/or preservative liquids (e.g., mold inhibiting emulsions). In an embodiment, the first liquid and the second liquid are each independently selected from a mold inhibiting emulsion according to the present invention.

With reference to FIGS. 1, 2 and 3, an apparatus 1 according to the present invention includes a first station 11 that includes a first nozzle 14 having a first spray sensor 17, a second nozzle 20 having a second spray sensor 23, and a first station vessel location sensor 26. As discussed previously herein, the first station can in some embodiments include two or more first nozzles, and/or two or more second nozzles, in which each first nozzle has a first spray sensor, and each second nozzle has a second spray sensor. Additional first and/or second nozzles can be included in the first station for reasons including, but not limited to, larger vessels passing there-through. For purposes of non-limiting illustration, first station 11 of apparatus 1 is depicted as including a single first nozzle 14 and a single second nozzle 20. The first and second nozzles of the first station may be vertically positioned by means of a linear actuator 35.

First station 11 may further include a protection plate 29 residing below the first 14 and second 20 nozzles. Protection plate 29 may be present for purposes of protecting the nozzles from impact with, for example, vessels moving there-below. Protection plate 29 may be attached to spring 32 residing there-above.

Apparatus 1 also includes a second station 38 that includes, a third nozzle 41 having a third spray sensor 44, a fourth nozzle 47 having a fourth spray sensor 50, and a second station vessel location sensor 53. As discussed previously herein, the second station can in some embodiments include two or more third nozzles, and/or two or more fourth nozzles, in which each third nozzle has a third spray sensor, and each fourth nozzle has a fourth spray sensor. Additional third and/or fourth nozzles can be included in the second station for reasons including, but not limited to, larger sizes of unbaked dough passing there-through. For purposes of non-limiting illustration, second station 38 of apparatus 1 is depicted as including a single third nozzle 41 and a single fourth nozzle 47. The third and fourth nozzles of the second station may be vertically positioned by means of a linear actuator 54. First station 11 and second station 38 are remote from each other, for example, being laterally separated from each other.

Second station 38 may further include a protection plate 57 residing below the third 41 and fourth 47 nozzles. Protection plate 57 may be present for purposes of protecting the nozzles from impact with, for example, vessels moving there-below. Protection plate 57 may be attached to spring 60 residing there-above.

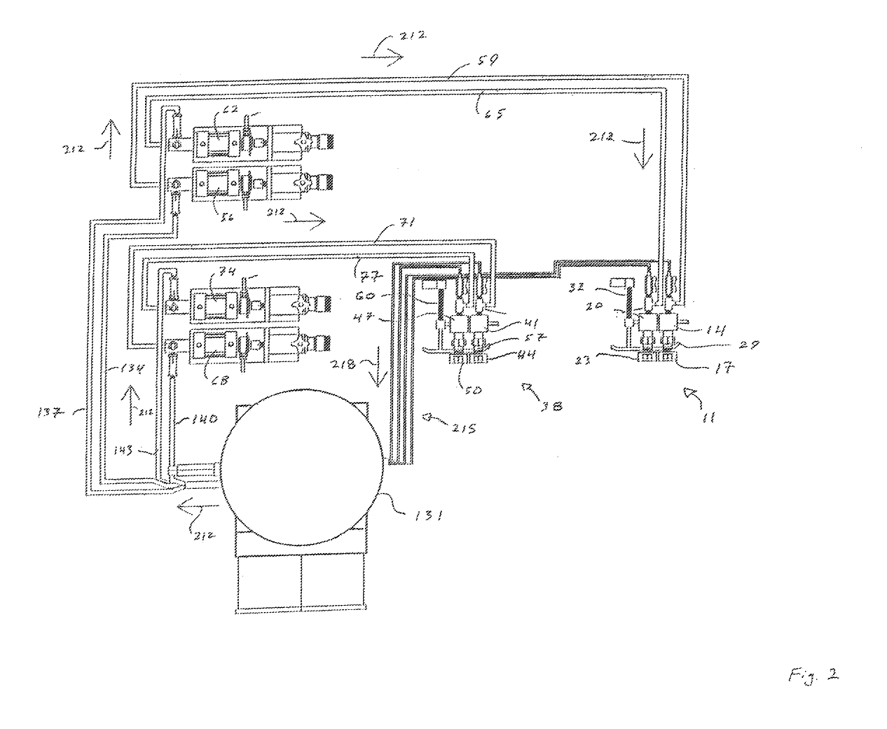

The apparatus of the present invention further includes a first pump 56 that is in fluid communication with first nozzle 14 by means of a first conduit 59, a second pump 62 that is in fluid communication with second nozzle 20 by means of second conduit 65, a third pump 68 that is in fluid communication with third nozzle 41 by means of a third conduit 71, and a fourth pump 74 that is in fluid communication with fourth nozzle 47 by means of a fourth conduit 77. See FIG. 2. In some embodiments, two or more first nozzles are present, and first pump 56 is in fluid communication with each first nozzle by means of first conduit 59 and a first conduit header (not shown). In some embodiments, two or more second nozzles are present, and second pump 62 is in fluid communication with each second nozzle by means of second conduit 65 and a second conduit header (not shown). In some embodiments, two or more third nozzles are present, and third pump 68 is in fluid communication with each third nozzle by means of third conduit 71 and a third conduit header (not shown). In some embodiments, two or more fourth nozzles are present, and fourth pump 74 is in fluid communication with each fourth nozzle by means of fourth conduit 77 and a fourth conduit header (not shown).

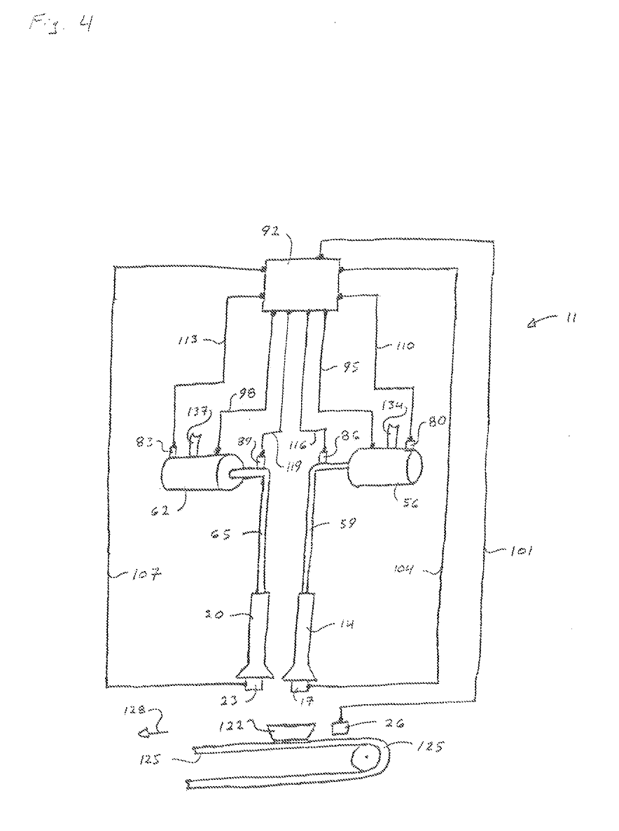

The first pump, second pump, third pump, and fourth pump each include a separate pump activation sensor. The pump activation sensors determine whether the pump has actually been activated in response to an activation command provided by a programmable controller, as will be discussed in further detail herein. For purposes of illustration and with reference to FIG. 4, first pump 56 has a pump activation sensor 80, and second pump 62 has a pump activation sensor 83. The depiction and description of the pump activation sensors (80, 83) of the first 56 and second 62 pumps, with reference to FIG. 4, is equivalently applicable to the pump activation sensors (not shown) of the third pump 68 and the fourth pump 74.

The first conduit, second conduit, third conduit and fourth conduit each include a separate liquid flow sensor. Each liquid flow sensor determines whether a liquid, such as mold inhibiting emulsion, is flowing through the conduit to the nozzle, in response to an activation command provided by the programmable controller to the pump to which the conduit is connected. For purposes of illustration and with reference to FIG. 4, first conduit 59 has a liquid flow sensor 86, and second conduit 65 has a liquid flow sensor 89. The liquid flow sensors may be positioned at any point along the conduit between the pump and nozzle, and may be selected from art-recognized and commercially available liquid flow sensors. The depiction and description of the liquid flow sensors (86, 89) of the first 59 and second 65 conduits, with reference to FIG. 4, is equivalently applicable to the liquid flow sensors (not shown) of the third conduit 71 and the fourth conduit 77.

The apparatus of the present invention further includes a programmable controller 92 that is independently controllably coupled to each of first pump 56, second pump 62, third pump 68 and fourth pump 74. The programmable controller may be controllably coupled to each of the pumps by art-recognized coupling means, such as wires, and multiplexed cables, such as USB cables, coaxial cables, and fiber optic cables. The controllable couplings (e.g., USB cables) allow the programmable controller to transmit commands to the pumps, and to optionally receive information (e.g., operational information, such as confirmation of pump activation) from the pumps. The programmable controller may include a plurality of programmable controllers that are coupled together, or a single programmable controller. The programmable controller typically includes a computer processing unit, a data storage and program storage unit (or separate units), one or more computer programs, one or more input/output modules, and a user interface (e.g., including a keyboard and visual monitor).

For purposes of illustration and with reference to FIG. 4, programmable controller 92 is controllably coupled to: first pump 56 by means of cable 95; and second pump 62 by means of cable 98. The depiction and description of the controllable coupling of programmable controller 92 to the first 56 and second 62 pumps by means of cables 95 and 98, with reference to FIG. 4, is equivalently applicable to the controllable coupling of programmable controller 92 to each of the third 68 and fourth 74 pumps, by means of additional cables (not shown).

The first station vessel location sensor and the second station vessel location sensors are each independently electrically connected to the programmable controller (e.g., by means of electrical wires). For purposes of illustration and with reference to FIG. 4, first station vessel location sensor 26 is electrically connected to programmable controller 92 by wire or cable 101. The depiction and description of the electrical connection between first station vessel location sensor 26 and programmable controller 92 by wire/cable 101, with reference to FIG. 4, is equivalently applicable to the electrical connection (not shown) between second station vessel location sensor 53 and programmable controller 92.

The first, second, third, and fourth spray sensors are each independently electrically connected to the programmable controller (e.g., by means of electrical wires). With reference to FIG. 4 and for purposes of illustration, first spray sensor 17 is electrically connected to programmable controller 92 by wire or cable 104, and second spray sensor 23 is electrically connected to programmable controller 92 by wire or cable 107. With some embodiments, two or more first nozzles, and/or two or more second nozzles, and/or two or more third nozzles, and/or two or more fourth nozzles are present, and each first spray sensor, each second spray sensor, each third spray sensor, and each fourth spray sensor can be independently electrically connected to the programmable controller in each case by a separate wire or cable (not shown). The depiction and description of the electrical connection between first 17 and second 23 spray sensors and programmable controller 92 by wires 101 and 107, with reference to FIG. 4, is equivalently applicable to the electrical connections (not shown) between third 44 and fourth 50 spray sensors and programmable controller 92.

The pump activation sensors of each of the first, second, third, and fourth pumps are in each case independently electrically connected to the programmable controller (e.g., by means of electrical wires). With reference to FIG. 4 and for purposes of illustration, pump activation sensor 80 of first pump 56 is electrically connected to programmable controller 92 by wire or cable 110, and pump activation sensor 83 of second pump 62 is electrically connected to programmable controller by wire or cable 113. The depiction and description of the electrical connections between pump activation sensors (80, 83) of the first 56 and second 62 pumps by wires/cables 110 and 113, with reference to FIG. 4, is equivalently applicable to the electrical connections (not shown) between the pump sensors (not shown) of the third 68 and fourth 74 pumps and programmable controller 92.

The liquid flow sensors of each of the first, second, third, and fourth conduits are in each case independently electrically connected to the programmable controller. For purposes of illustration and with reference to FIG. 4, liquid flow sensor 86 of first conduit 59 is electrically connected to programmable controller 92 by wire or cable 116, and liquid flow sensor 89 of second conduit 65 is electrically connected to programmable controller 92 by wire or cable 119. The depiction and description of the electrical connections between liquid flow sensors (86, 89) of the first 59 and second 65 conduits by wires/cables 116 and 119, with reference to FIG. 4, is equivalently applicable to the electrical connections (not shown) between the liquid flow sensors (not shown) of the third 71 and fourth 77 conduits and programmable controller 92.

The operation of the apparatus of the present invention is described as follows. The first station vessel sensor 26 is adapted to determine and inform programmable controller 92 (via wire 101) that a vessel 122 has entered and is present within first station 11. In response to this information, programmable controller 92 provides an activation command through cable 95 to first pump 56, so as to activate first pump 56. First pump 56, being so activated, introduces a first liquid, such as a mold inhibiting emulsion according to the present invention, into and through first conduit 59 and into first nozzle 14. The first liquid emerges from first nozzle 14 and is applied to a contact surface (e.g., internal or upper surfaces) of vessel 122.

If an operational failure is detected by at least one of the sensors associated with the first pump, first conduit and/or first nozzle(s), the programmable controller will activate the second pump, while the vessel is still within the first station, resulting in the first liquid passing into each second nozzle and onto the contact surface of the vessel from at least one second nozzle. In some embodiments each second nozzle includes a second nozzle valve that can each be individually actuated (e.g., opened) by the programmable controller when failure of a corresponding (e.g., a positionally corresponding) first nozzle is detected. More particularly, if one or more of, the pump activation sensor 80 of first pump 56 detects failure of the first pump, the liquid flow sensor 86 of first conduit 59 detects failure of flow of the first liquid (e.g., mold inhibiting emulsion) therethrough, and/or first spray sensor 17 detects failure of the first liquid (e.g., mold inhibiting emulsion) to spray from the first nozzle, then programmable controller 92 activates (by means of controllable coupling 98) second pump 62 to introduce the first liquid (e.g., mold inhibiting emulsion) into and through second conduit 65 into second nozzle 20 and onto the contact surface of vessel 122.

If an operational failure is detected by at least one of the sensors associated with the second pump, second conduit, and/or second nozzle(s), the programmable controller will transmit or generate a first station failure alarm, which may include, for example, visual alarms (e.g., flashing lights) and/or audible alarms (e.g., horns and/or bells). In addition to transmitting a first station failure alarm, the programmable controller may optionally shut down the line. Restarting the line may require intervention by a human operator. More particularly, if at least one of, the pump activation sensor 83 of second pump 62 detects failure of the second pump, the liquid flow sensor 89 of second conduit 65 detects failure of flow of the first liquid (e.g., mold inhibiting emulsion) therethrough, or second spray sensor 23 detects failure of the first liquid (e.g., mold inhibiting emulsion) to spray from second nozzle 23, then programmable controller 92 will promptly transmit a first station failure alarm.

With regard to operation of the second station, second station vessel sensor 53 is adapted to detect and inform programmable controller 92 (via the electrical connection there-between, not shown) that vessel 122, having unbaked dough therein (not shown), has entered and is present within second station 38. In response to this information, programmable controller 92 provides an activation command (through a controllable coupling, not shown) to third pump 68, so as to activate third pump 68. Third pump 68, being so activated, introduces a second liquid (e.g., mold inhibiting emulsion) into and through third conduit 71 and into third nozzle 41. The second liquid (e.g., mold inhibiting emulsion) emerges from third nozzle 41 and is applied onto an upper portion of the exterior surface of the unbaked dough that resides within and is free of contact with the previously treated contact surfaces of vessel 122.

If an operational failure is detected by at least one of the sensors associated with the third pump, third conduit and/or third nozzle(s), the programmable controller will activate the fourth pump, while the vessel (containing unbaked dough) is still within the second station, resulting in the second liquid passing into each fourth nozzle and onto the exterior surface of the unbaked from at least one fourth nozzle. In some embodiments each fourth nozzle includes a fourth nozzle valve that can each be individually actuated (e.g., opened) by the programmable controller when failure of a corresponding (e.g., a positionally corresponding) third nozzle is detected. More particularly, if one or more of, the pump activation sensor of third pump 68 detects failure of the third pump, the liquid flow sensor of third conduit 71 detects failure of flow of the second liquid (e.g., mold inhibiting emulsion) therethrough, and/or third spray sensor 44 detects failure of the second liquid (e.g., mold inhibiting emulsion) to spray from the third nozzle, then programmable controller 92 activates (by means of a controllable coupling, not shown) fourth pump 74 to introduce the second liquid (e.g., mold inhibiting emulsion) into and through fourth conduit 77 into fourth nozzle 47 and onto an upper portion of the exterior surface of the unbaked dough that is free of contact with the previously treated contact surface of vessel 122.

If an operational failure is detected by at least one of the sensors associated with the fourth pump, fourth conduit, and/or fourth nozzle(s), the programmable controller will transmit or generate a second station failure alarm, which may include, for example, visual alarms (e.g., flashing lights) and/or audible alarms (e.g., horns and/or bells). In addition to transmitting a second station failure alarm, the programmable controller may optionally shut down the line. Restarting the line may require intervention by a human operator. More particularly, if at least one of, the pump activation sensor of fourth pump 74 detects failure of the fourth pump, the liquid flow sensor of fourth conduit 77 detects failure of flow of the second liquid (e.g., mold inhibiting emulsion) therethrough, or fourth spray sensor 50 detects failure of the second liquid (e.g., mold inhibiting emulsion) to spray from fourth nozzle 47, then programmable controller 92 will promptly transmit or generate a second station failure alarm.

The vessels may be moved or transported through and between the first and second stations by suitable methods, for example, manually, on trucks and/or on a continuous belt. In an embodiment, the apparatus of the present invention further includes a continuous belt that resides vertically beneath the first, second, third and fourth nozzles. The vessel is moveable through and between the first station and the second station while residing on the continuous belt. With reference to FIGS. 1 and 4, a continuous belt 125 is depicted. In FIGS. 1 and 4, arrow 128 indicates the direction in which vessels (e.g., vessel 122) are moved through and between the first 11 and second 38 stations on the continuous belt 125.

The apparatus of the present invention may include one or more reservoirs containing liquid (e.g., mold inhibiting emulsion) that provide liquid to the first, second, third and fourth pumps. In an embodiment, the first and second liquids are the same liquid, and the apparatus includes a reservoir 131 containing liquid (e.g., mold inhibiting emulsion). Reservoir 131 is in fluid communication with each of the first 56, second 62, third 68 and fourth 74 pumps.

With reference to FIG. 2, reservoir 131 is in fluid communication with: first pump 56 by means of first feed conduit 134; second pump 62 by means of second feed conduit 137; third pump 68 by means of third feed conduit 140; and fourth pump 74 by means of fourth feed conduit 143.

The arrows 212 in FIG. 2 indicate the flow of liquid between reservoir 131, the pumps and the nozzles. Each of the first, second, third and fourth nozzles may independently be additionally and optionally connected to reservoir 131 by means of return conduits 215. The return conduits 215 may serve as purge lines for purposes of purging gas and/or liquid from the nozzles. The flow of material from the nozzles through return lines 215 back to reservoir 131 is depicted by arrow 218.

The liquid, such as mold inhibiting emulsion, may be drawn from the reservoir by each of the pumps and/or delivered to each of the pumps by one or more reservoir pumps that is positioned in-line between the reservoir and the pumps. In an embodiment, the apparatus further includes a reservoir pump 146 that is positioned in-line between the reservoir and each of the pumps. Reservoir pump 146 pumps liquid (e.g., mold inhibiting emulsion) to each of the first, second, third, and fourth pumps.

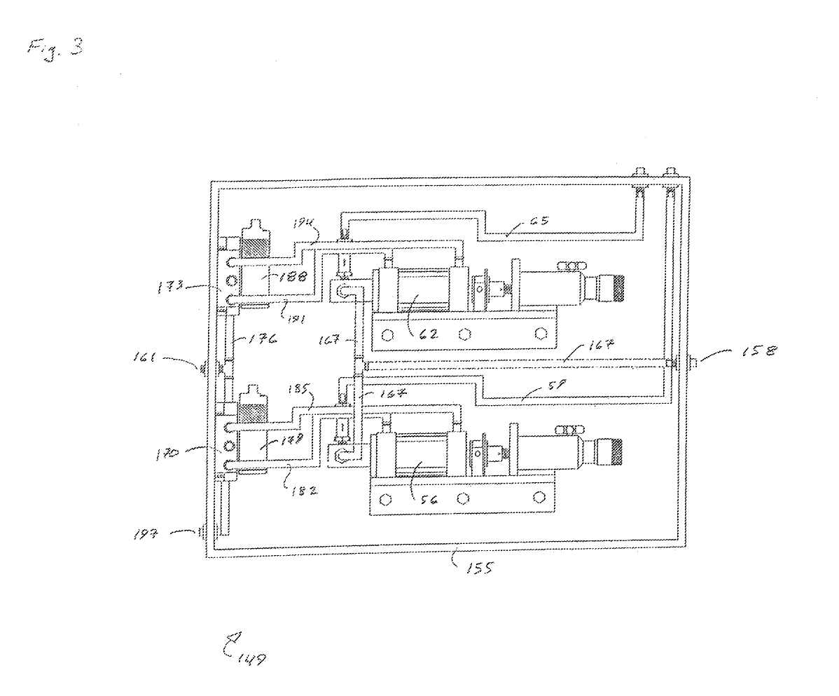

The reservoir pump may be connected to each of the pumps by a separate conduit, or by a header system. In an embodiment, the first 56 and second 62 pumps are housed in a first pump station 149, and the third 68 and fourth 74 pumps are housed in a second pump station 152. With reference to FIG. 3, first pump station 149 includes a pump station wall 155, a liquid inlet 158, a gas inlet 161, and an electrical inlet 197. Reservoir pump 146 is in fluid communication with liquid inlet 158 by means of conduit 164 (FIG. 1). Liquid inlet 158 is in fluid communication with both first pump 56 and second pump 62 by means of liquid header 167. Gas inlet 161 is in fluid communication with a pressurized gas (e.g., air) source (not shown). Gas inlet 161 is in fluid communication with a first gas header 170 and a second gas header 173 by means of conduit 176. First gas header 170 includes a first solenoid 179 that alternately provides pressurized gas to first pump 56 through conduits 182 and 185. Second gas header 173 includes a second solenoid 188 that alternately provides pressurized gas to second pump 62 through conduits 191 and 194.

The configuration of second pump station 152 is substantially the same as that of first pump station 149, as described and depicted with reference to FIG. 3. For example, and as depicted in part in FIG. 1, reservoir pump 146 is in fluid communication with second pump station 152 by means of conduit 200. Second pump station 152 also includes a gas inlet 203, a third solenoid 206, and a fourth solenoid 209.

The first, second, third, and fourth spray sensors may each independently be selected from suitable sensors that would detect the emergence of liquid spray from the respective nozzles. For example, the spray sensors may be selected from mechanical sensors (e.g., one or more paddles that are moved by the spray), potentiometric sensors (e.g., that are activated by contact with the liquid spray), and/or optical sensors (e.g., photoelectric sensors). In an embodiment, the first spray sensor, the second spray sensor, the third spray sensor, and the fourth spray sensor are each independently selected from photoelectric sensors.

The apparatus of the present invention may optionally include an unbaked dough introduction assembly that serves to introduce unbaked dough into the treated vessels after they have been treated in the first station and before entering the second station. With reference to FIG. 1, apparatus 1 further includes an unbaked dough introduction assembly 3 that is positioned between first station 11 and second station 38, and vertically above continuous belt 125. Dough introduction assembly 3 includes a first continuous belt 221 that is positioned vertically above and partially over a second continuous belt 224. Shaped unbaked dough (not shown) is deposited onto first continuous belt 221 (e.g., into a container 227 residing on first continuous belt 221). The shaped unbaked dough is then transferred from first continuous belt 221 down to second continuous belt 224, from where it is then further transferred (e.g., dropped) down into a treated vessel (not shown in FIG. 1) residing on continuous belt 125. The treated vessel containing the shaped unbaked dough, introduced therein from second continuous belt 224, is then transported on continuous belt 125 to second station 38.

The present invention is more particularly described in the following examples, which are intended to be illustrative only, since numerous modifications and variations therein will be apparent to those skilled in the art. Unless otherwise specified, all parts and percentages are by weight.

### Examples

Unbaked dough from which control loaves of bread (Dough-A), and unbaked dough that was treated with mold inhibiting emulsions according to the present invention and in accordance with the method of the present invention (Dough-B) were prepared from ingredients as summarized in the following Table 1.

TABLE 1

| | | |
|---|---|---|
| | Dough-A | Dough-B |
| Material | (grams) | (grams) |

Charge-1

| | | |
|---|---|---|
| Flour⁽¹⁾ | 1588 | 1588 |
| Water | 907 | 907 |
| Yeast⁽²⁾ | 23 | 23 |

Charge-2

| | | |
|---|---|---|
| Flour⁽¹⁾ | 340 | 340 |
| Water | 227 | 227 |
| Granulated sugar⁽³⁾ | 68 | 68 |
| Shortening⁽⁴⁾ | 45 | 45 |
| Powdered milk⁽⁵⁾ | 23 | 23 |
| Salt | 23 | 23 |
| Yeast⁽²⁾ | 28 | 10 |
| Emulsifier⁽⁶⁾ | 12 | 12 |
| Calcium propionate⁽⁷⁾ | 6.8 | 0.7 |

⁽¹⁾The flour used was bread flour, obtained commercially from Pillsbury.
⁽²⁾The yeast used was standard powdered yeast, obtained commercially from Fleishman.
⁽³⁾The granulated sugar was obtained commercially from Domino, under the tradename Fine Granulated.
⁽⁴⁾The shortening was obtained commercially from Mallet & Co, Inc., under the tradename Satin Glo.
⁽⁵⁾The powdered milk was obtained commercially from Nestles.
⁽⁶⁾The emulsifier used was mono and diglycerides, and was obtained commercially from Malett & Co., Inc., under the tradename Prosoft Silver.
⁽⁷⁾The calcium propionate was obtained commercially from Niacet.

The ingredients of Charge-1 were in each case added to a Hobart mixer. With the ingredients of Charge-1 thoroughly mixed, the ingredients of Charge-2 were then added to the mixer, on top of Charge-1, with continual mixing. When the combination of Charge-1 and Charge-2 were thoroughly mixed, as determined by visual inspection, the dough was removed from the mixer and shaped into dough logs or tubes, each weighing approximately 352 grams.

A small amount of calcium propionate was included in the dough of Dough-B for purposes of minimizing the formation of rope. The amount of calcium propionate included in the dough of Dough-B was 0.02 percent by weight, compared to 0.2 percent by weight for Dough-A, the percent weights in each case being based on total weight of ingredients.

The mold inhibiting emulsion used to treat the dough logs of Dough-B was prepared from ingredients summarized in the following Table 2.

TABLE 2

| Material | Percent by Weight |
|---|---|
| Mono and diglycerides⁽⁸⁾ | 10.7 |
| Polysorbate 60⁽⁹⁾ | 7.2 |
| Water | 79.1 |
| Potassium sorbate⁽¹⁰⁾ | 3.0 |

⁽⁸⁾Mono and diglycerides of oleic acid obtained commercially from Caravan Ingredients, under the tradename ATMOS 300.
⁽⁹⁾The polysorbate 60 was obtained commercially from Lonza, under the tradename Glycosperse.
⁽¹⁰⁾The potassium sorbate was obtained commercially from Univar, under the tradename Potassium Sorbate.

The mold inhibiting emulsion was prepared by mixing the ingredients summarized in Table 2 in a suitable container with an impeller so as to form a premix. The premix was homogenized by a high speed mixer until a stable emulsion was formed. The resulting mold inhibiting emulsion had: a viscosity of 1800 cps at 27° C., as determined using a Brookfield viscometer model number RVF, using a number 3 spindle at 20 rpm.

The dough logs of Dough-A were placed in metal pans that had been treated with a releasing agent, and allowed to rise at 100° F. for approximately 60 minutes. The raised dough logs of Dough-A were then baked in a gas fired oven at 177° C. for 25 minutes. Loaves of bread prepared from Dough-A are referred to herein below as Control loaves.

Pans in which the dough logs of Dough-B were to be placed were first treated with a releasing agent, and then sprayed with the mold inhibiting emulsion of Table 2. After placing the dough logs of Dough-B into the emulsion treated pans, the upper portion of the exterior surface of the dough logs of Dough-B were sprayed with the mold inhibiting emulsion of Table 2. A hand operated Wagoner airless spray gun (model no. 0525150) was used to spray the mold inhibiting emulsion into the pans and onto the dough logs of Dough-B.

After the dough logs of Dough-B were sprayed with mold inhibiting emulsion, they were allowed to rise at 100° F. for approximately 60 minutes. The raised dough logs of Dough-B were then baked in a gas fired oven at 177° C. for 25 minutes. Loaves of bread prepared from Dough-B are referred to herein below as Experimental loaves. The raised dough logs of Dough-A and Dough-B were not together baked in the same oven.

The weight of mold inhibiting emulsion sprayed into the pans and onto the dough logs of Dough-B was weighed, and is summarized in the following Table 3.

TABLE 3

| Dough-B | 1 | 2 | 3 | 4 | 5 |
|---|---|---|---|---|---|
| Sprayed into pan^{(a)} | 1.8 | 1.1 | 3.7 | 1.5 | 3.0 |
| Sprayed onto dough^{(b)} | 2.6 | 2.0 | 3.0 | 1.5 | 3.0 |

^{(a)}Weight (grams) of mold inhibiting emulsion of Table 2 that was sprayed into the pan.
^{(b)}Weight (grams) of mold inhibiting emulsion of Table 2 that was sprayed onto the dough logs of Dough-B.

The baked bread was removed from the oven, allowed to cool to room temperature, and then placed in polyethylene bags that were closed with twist ties. The Experimental and Control loaves were together stored under ambient conditions (e.g., about 25° C., and about 60 percent relative humidity). The loaves were visually inspected at regular intervals, without removing them from the bags to determine whether mold had begun to grow on the exterior surfaces of the loaves. The onset of mold growth was determined if discolored spots of at least about 1-2 mm in diameter were visually observed on the surface of a loaf.

The results of the storage stability evaluation are summarized in the following Tables A and B. The Experimental loaves 1, 2 and 3 were evaluated with a Control loaf at one time, and the Experimental loaves 4 and 5 were evaluated with a separate Control loaf at a separate time.

TABLE A

| | Loaf | | | |
|---|---|---|---|---|
| Time (days)^{(c)} | Exp-1 | Exp-2 | Exp-3 | Control |
| 7 | No mold | No mold | No mold | No mold |
| 13 | No mold | No mold | No mold | Mold |
| 25 | No mold | No mold | No mold | Mold |
| 36 | No mold | No mold | No mold | Mold |
| 56^{(d)} | No mold | No mold | No mold | Mold |

^{(c)}Days after the loaves of bread were prepared and baked.
^{(d)}The loaves were not further evaluated after the 56^{th} day.

TABLE B

Loaf

| Time (days)^{(c)} | Exp-4 | Exp-5 | Control |
|---|---|---|---|
| 5 | No mold | No mold | No mold |
| 14 | No mold | No mold | Mold |
| 19 | No mold | No mold | Mold |
| 32 | No mold | No mold | Mold |
| 54 | No mold | No mold | Mold |
| 56^{(d)} | No mold | No mold | Mold |

^{(c)}Days after the loaves of bread were prepared and baked.
^{(d)}The loaves were not further evaluated after the 56^{th} day.

The results summarized in Tables A and B clearly show that edible baked products prepared from dough treated with the mold inhibiting emulsions and in accordance with the methods of the present invention, have significantly enhanced resistance to mold growth when stored at ambient conditions. In addition, the dough (Dough-B) used to prepare the Experimental loaves required less yeast (0.3 percent by weight, based on total weight of ingredients), than the dough (Dough-A) used to prepare the Control loaves (0.9 percent by weight, based on total weight of ingredients). See Table 1.

The present invention has been described with reference to specific details of particular embodiments thereof. It is not intended that such details be regarded as limitations upon the scope of the invention except insofar as and to the extent that they are included in the accompanying claims.

What is claimed is:

1. A mold inhibiting emulsion comprising:
(a) an aqueous phase comprising water;
(b) a non-aqueous phase;
(c) at least one emulsifier; and
(d) at least one mold inhibitor,
wherein said mold inhibiting emulsion has a viscosity of at least 100 cps at 27° C.

2. The mold inhibiting emulsion of claim 1, wherein a continuous phase of said mold inhibiting emulsion comprises said aqueous phase.

3. The mold inhibiting emulsion of claim 1, wherein a continuous phase of said mold inhibiting emulsion comprises said non-aqueous phase.

4. The mold inhibiting emulsion of claim 1, wherein said mold inhibitor is selected from the group consisting of sorbic acid, sodium sorbate, potassium sorbate, calcium sorbate, propionic acid, sodium propionate, potassium propionate, calcium propionate, benzoic acid, sodium benzoate, potassium benzoate, calcium benzoate, and combinations thereof.

5. The mold inhibiting emulsion of claim 1, wherein said emulsifier is selected from the group consisting of monoglycerides, diglycerides, polysorbates, polyglycerol esters, lecithins, and combinations thereof.

6. The mold inhibiting emulsion of claim 1, wherein said non-aqueous phase comprises an oil selected from the group consisting of animal oils, vegetable oils, and combinations thereof.

7. A method of inhibiting mold growth on an edible baked product comprising:
(a) providing a mold inhibiting emulsion comprising,
(i) an aqueous phase comprising water,
(ii) a non-aqueous phase,
(iii) at least one emulsifier, and
(iv) at least one mold inhibitor,
wherein said mold inhibiting emulsion has a viscosity of at least 100 cps at 27° C.;
(b) treating an exterior surface of an unbaked dough with said mold inhibiting emulsion, thereby forming a treated unbaked dough; and
(c) baking said treated unbaked dough, thereby forming said edible baked product.

8. The method of claim 7, wherein said edible baked product is an edible leavened baked product.

9. The method of claim 7, wherein treating said exterior surface of said unbaked dough comprises applying said mold inhibiting emulsion as an atomized mold inhibiting emulsion to said exterior surface of said unbaked dough.

10. The method of claim 7 further comprising,
providing a first mold inhibiting emulsion and a second mold inhibiting emulsion each independently selected from said mold inhibiting emulsion, wherein said first mold inhibiting emulsion and said second mold inhibiting emulsion are the same or different, and
further wherein treating said exterior surface of said unbaked dough with said mold inhibiting emulsion comprises,
applying said first mold inhibiting emulsion to a contact surface of a vessel in which said unbaked dough is baked, thereby forming a treated vessel;
introducing said unbaked dough into said treated vessel, wherein an upper portion of said exterior surface of said unbaked dough is free of contact with said contact surface of said treated vessel, and
applying said second mold inhibiting emulsion to said upper portion of said exterior surface of said unbaked dough, within said treated vessel.

11. The method of claim 7, wherein substantially all of said exterior surface of said unbaked dough is treated with said mold inhibiting emulsion.

12. The method of claim 10, wherein,
said first mold inhibiting emulsion is applied to substantially all of said contact surface of said vessel, and
said second mold inhibiting emulsion is applied to substantially all of said upper portion of said exterior surface of said unbaked dough, within said treated vessel.

13. An apparatus for treating an exterior surface of an unbaked dough, comprising:
(a) a first station comprising at least one first nozzle each having a first spray sensor, at least one second nozzle each having a second spray sensor, and a first station vessel location sensor;
(b) a second station comprising at least one third nozzle each having a third spray sensor, at last one fourth nozzle each having a fourth spray sensor, and a second station vessel location sensor, said first station and said second station being remote from each other;
(c) a first pump that is in fluid communication with each first nozzle by means of a first conduit, a second pump that is in fluid communication with each second nozzle by means of a second conduit, a third pump that is in fluid communication with each third nozzle by means of a third conduit, and a fourth pump that is in fluid communication with each fourth nozzle by means of a fourth conduit,
wherein said first pump, said second pump, said third pump, and said fourth pump each independently have a pump activation sensor, and
wherein said first conduit, said second conduit, said third conduit, and said fourth conduit each independently have a liquid flow sensor; and
(d) a programmable controller that is independently controllably coupled to each of said first pump, said second pump, said third pump, and said fourth pump;
wherein said first station vessel location sensor and said second station vessel location sensor are each independently electrically connected to said programmable controller,
wherein each first spray sensor, each second spray sensor, each third spray sensor, and each fourth spray sensor are each independently electrically connected to said programmable controller,
wherein the pump activation sensor of each of said first pump, said second pump, said third pump, and said fourth pump is in each case independently electrically connected to said programmable controller, and
wherein the liquid flow sensor of each of said first conduit, said second conduit, said third conduit, and said fourth conduit is in each case independently electrically connected to said programmable controller,
wherein said first station vessel sensor is adapted to inform said programmable controller that a vessel is present within said first station, said programmable controller activating said first pump to introduce a first liquid through said first conduit into each first nozzle and onto a contact surface of said vessel,
wherein if at least one of, said pump activation sensor of said first pump detects failure of said first pump, said liquid flow sensor of said first conduit detects failure of flow of said first liquid therethrough, or at least one first spray sensor detects failure of said first liquid to spray from at least one first nozzle, said programmable controller activates said second pump to introduce said first liquid through said second conduit into each second nozzle and onto said contact surface of said vessel,
wherein if at least one of, said pump activation sensor of said second pump detects failure of said second pump, said liquid flow sensor of said second conduit detects failure of flow of said first liquid therethrough, or at last one second spray sensor detects failure of said first liquid to spray from at least one second nozzle, said programmable controller transmits a first station failure alarm,
wherein said second station vessel sensor is adapted to inform said programmable controller that said vessel, having unbaked dough therein, is present within said second station, said programmable controller activating said third pump to introduce a second liquid through said third conduit into each third nozzle and onto an upper portion of said exterior surface of said unbaked dough that is free of contact with said contact surface of said vessel,
wherein if at least one of, said pump activation sensor of said third pump detects failure of said third pump, said liquid flow sensor of said third conduit detects failure of flow of said second liquid therethrough, or at least one third spray sensor detects failure of said second liquid to spray from at least one third nozzle, said programmable controller activates said fourth pump to introduce said second liquid through said fourth conduit into each fourth nozzle and onto said upper portion of said exterior surface of said unbaked dough, and
wherein if at least one of, said pump activation sensor of said fourth pump detects failure of said fourth pump, said liquid flow sensor of said fourth conduit detects failure of flow of said second liquid therethrough, or at least one fourth spray sensor detects failure of said second liquid to spray from at least one fourth nozzle, said programmable controller transmits a second station failure alarm.

14. The apparatus of claim 13 further comprising a continuous belt residing beneath each first nozzle, each second nozzle, each third nozzle and each fourth nozzle, wherein said vessel is movable through said first station and said second station on said continuous belt.

15. The apparatus of claim 13, wherein said first liquid and said second liquid are the same, and said apparatus further comprising a reservoir containing said first liquid and said second liquid, wherein said reservoir is in fluid communication with each of said first pump, said second pump, said third pump, and said fourth pump.

16. The apparatus of claim 15 further comprising a reservoir pump that pumps said first liquid and said second liquid to each of said first pump, said second pump, said third pump, and said fourth pump.

17. The apparatus of claim 13, wherein each first spray sensor, each second spray sensor, each third spray sensor, each fourth spray sensor, said first station vessel location sensor, and said second station vessel location sensor are each individually selected from photoelectric sensors.

18. The apparatus of claim 13, wherein said first liquid and said second liquid are each independently selected from a mold inhibiting emulsion comprising:
(a) an aqueous phase comprising water;
(b) a non-aqueous phase;
(c) at least one emulsifier; and
(d) at least one mold inhibitor,
wherein said mold inhibiting emulsion has a viscosity of at least 100 cps at 27° C.
